(19) United States
(12) Patent Application Publication
(10) Pub. No.: US 2014/0189722 A1
(43) Pub. Date: Jul. 3, 2014

(54) METHOD AND APPARATUS FOR UTILITY SERVICE CONSUMPTION CONTROL

(71) Applicant: VERIZON PATENT AND LICENSING INC., Basking Ridge, NJ (US)

(72) Inventor: Rajesh Gopal SHETTY, Flower Mound, TX (US)

(73) Assignee: VERIZON PATENT AND LICENSING INC., Basking Ridge, NJ (US)

(21) Appl. No.: 13/733,644

(22) Filed: Jan. 3, 2013

(51) Int. Cl. H04N 21/442

(52) U.S. Cl. CPC H04N 21/44204
USPC 725/14

(57) ABSTRACT

An approach for adjusting the consumption of utility services based on determined usage trends includes collecting utility data, at a customer premise equipment, associated with consumption of a utility service at a customer premise, forwarding the collected utility data from the customer premise equipment to a service provider network to determine a usage trend in the consumption of the utility service, and adjusting the consumption of the utility service based on the determined usage trend and a user specified usage criterion.

### BACKGROUND INFORMATION

Utility providers acquire vast amounts of utility data with respect to the consumption of utility services from customers, both commercial and residential. Although customers are provided with the consumption information as part of periodic billing procedures, customers do not have an effective way of controlling the consumption of the utility services based on the consumption information. Rather, customers are left to control the consumption of the utility services based on manually setting one or more thresholds and wait to determine if the consumption is in accord with one or more thresholds with respect to, for example, cost associated with the consumption. Yet, manually setting one or more thresholds fails to consider the dynamic aspects associated with the consumption of utility services. Moreover, such manual process is cumbersome and time consuming.

Therefore, there is a need for an approach to adjust the consumption of utility services based on determined usage trends and a user specified usage criterion.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of adjusting the consumption of utility services based on determined usage trends, according to one embodiment;

FIG. 2 is a diagram of components of a utility monitoring platform in the system of FIG. 1, according to one embodiment;

FIG. 3 is a flowchart of a process for adjusting the consumption of utility services based on determined usage trends, according to one embodiment;

FIG. 4 is a flowchart of a process for accounting for external parameters and/or utility rates in adjusting the consumption of utility services based on determined usage trends, according to one embodiment;

FIG. 5 is a flowchart of a process for providing notifications associated with issues in the consumption of utility services, according to one embodiment;

FIG. 6 is a diagram of a computer system that can be used to implement various exemplary embodiments; and

FIG. 7 is a diagram of a chip set that can be used to implement various exemplary embodiments.

### DESCRIPTION OF THE PREFERRED EMBODIMENT

A preferred apparatus, method, and system for adjusting the consumption of utility services based on determined usage trends and specified usage criterions are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a set-top box (STB), it is contemplated that these embodiments have applicability to any device capable of processing audio-video (AV) signals for presentation to a user, such as a home communication terminal (HCT), a digital home communication terminal (DHCT), a stand-alone personal video recorder (PVR), a television set, a digital video disc (DVD) player, a video-enabled phone, an AV-enabled personal digital assistant (PDA), and/or a personal computer (PC), as well as other like technologies and customer premise equipment (CPE).

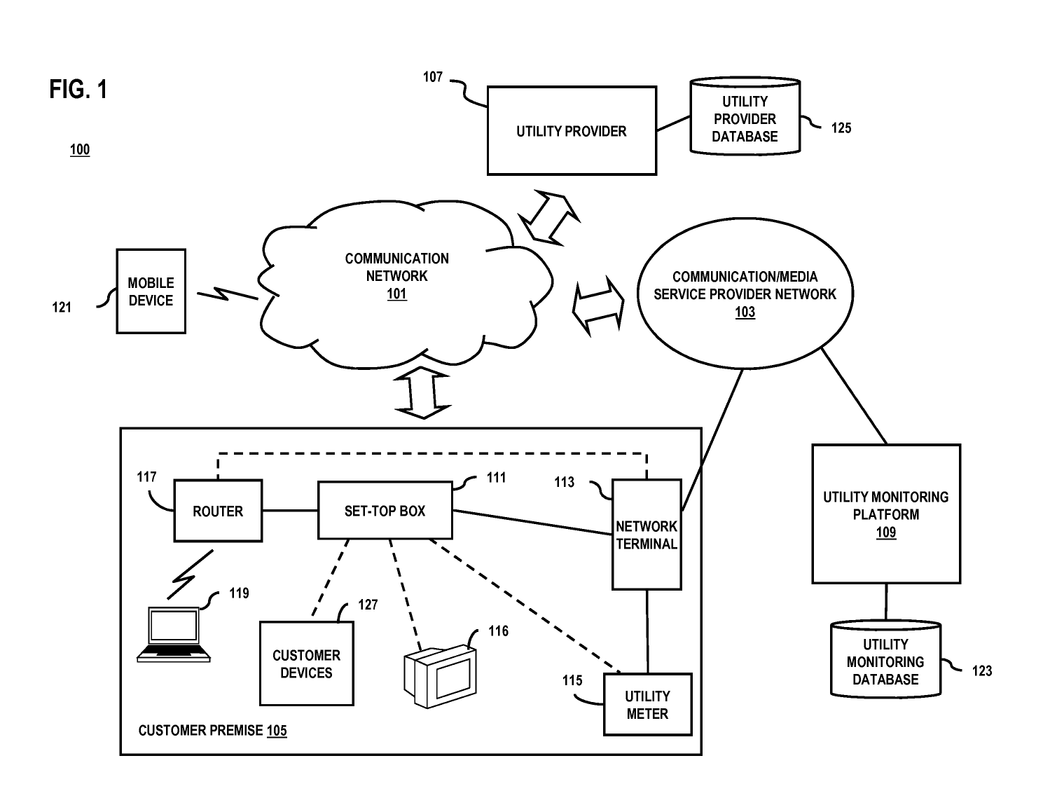

FIG. 1 is a diagram of a system 100 capable of adjusting the consumption of utility services based on determined usage trends and specified usage criterions, according to one embodiment. For the purposes of illustration, a mechanism for adjusting the consumption of utility services based on determined usage trends is described with respect to system 100, which includes a communication network 101 that provides connectivity between a communication/media service provider network 103 and a user or customer premise 105. Under this scenario, the service provider network 103 can also interface with a utility provider 107 using the communication network 101. According to certain embodiments, the service provider network 103 includes a utility monitoring platform 109 for communicating with the utility provider 107 to exchange utility data relating to the consumption of a utility service. For example, the utility monitoring platform 109 can receive utility data from a set-top box (STB) 111 within the customer premise 105. This capability, in some embodiments, is provided as a managed service on a subscription basis, whereby subscribers undergo a registration process for the utility monitoring and control service.

In one embodiment, the service provider that operates the service provider network 103 may be an entity that provides communications and/or media delivery services to users (e.g. subscribers, customers, etc.). These services can include wireless phone services, wireline phone services, Internet services, content services (such as TV), etc. In one embodiment, the service provider can provide a bundled communications (Internet, telephone, and TV) service such as FiOS®. The service provider can distribute media content through the service provider network 103 directly or indirectly via the communication network 101 to the customer premise 105. Such content can be received by the set-top box 111 directly or through a network terminal 113 (which, for example, may be an optical network terminal (ONT) in the case of FiOS®).

In one embodiment, the set-top box 111 interfaces with a utility meter 115 through the network terminal 113. The network terminal 113 can be a device that serves as an interface to the service provider network 103. The utility meter 115 measures the consumption of the utility service by the customer premise 105. Alternatively, the utility meter 115 can be configured to communicate directly with the set-top box 111 using a wireless link or a wired link.

As used herein, the terms set-top box, media-based device, and user equipment are interchangeable, to denote a device capable of receiving content from the service provider network 103. Furthermore, content is contemplated broadly to include a wide range of media. Content can include any audio-video content (e.g., broadcast television programs, digital video recorder (DVR) content, on-demand programs, pay-per-view programs, IPTV (Internet Protocol Television) feeds, DVD related content, etc.), pre-recorded media content, data communication services content (e.g., commercials, advertisements, videos, movies, etc.), Internet-based content (e.g., streamed video), and/or any other equivalent media form.

Furthermore, the set-top box 111 can be used to receive voice, video, and data from the network terminal 113 and to present such content to various devices, such as a display 116. In one embodiment, a router 117 can be connected to the set-top box 111 and can provide access to a public data network (e.g., the global Internet) to a user device, such as computing device 119 (e.g., laptop, desktop computer, web appliance, etc.). Alternatively or additionally, the router 117 can be directly connected to the network terminal 113. In another embodiment, the router 117 can be included in (or integrated with) the set-top box 111, such that the set-top box 111 can provide, for instance, access to the Internet to the device 119. However, it is contemplated that other combinations may be provided.

In accordance with certain embodiments, a mobile device 121 can communicate with the utility monitoring platform 109 to manage the user's account for the utility service over the communication network 101.

By way of example, the communication network 101 may include one or more networks such as a data network and/or a telephony network. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. Moreover, the telephony network can be provided via a combination of circuit-switched technologies or a packetized voice infrastructure.

Also, the communication network 101 can include a radio network that supports wireless terminals, which may be fixed or mobile, using various radio access technologies. Different radio technologies are contemplated: first generation (1G) technologies (e.g., advanced mobile phone system (AMPS), cellular digital packet data (CDPD), etc.), second generation (2G) technologies (e.g., global system for mobile communications (GSM), interim standard 95 (IS-95), etc.), third generation (3G) technologies (e.g., code division multiple access 2000 (CDMA2000), general packet radio service (GPRS), universal mobile telecommunications system (UMTS), etc.), 4G, etc. For instance, various mobile communication standards have been introduced, such as first generation (1G) technologies (e.g., advanced mobile phone system (AMPS), cellular digital packet data (CDPD), etc.), second generation (2G) technologies (e.g., global system for mobile communications (GSM), interim standard 95 (IS-95), etc.), third generation (3G) technologies (e.g., code division multiple access 2000 (CDMA2000), general packet radio service (GPRS), universal mobile telecommunications system (UMTS), etc.), and beyond 3G technologies (e.g., third generation partnership project (3GPP) long term evolution (3GPP LTE), 3GPP2 universal mobile broadband (3GPP2 UMB), etc.).

Complementing the evolution in mobile communication standards adoption, other radio access technologies have also been developed by various professional bodies, such as the Institute of Electrical and Electronic Engineers (IEEE), for the support of various applications, services, and deployment scenarios. For example, the IEEE 802.11 standard, also known as wireless fidelity (WiFi), has been introduced for wireless local area networking, while the IEEE 802.16 standard, also known as worldwide interoperability for microwave access (WiMAX) has been introduced for the provision of wireless communications on point-to-point links, as well as for full mobile access over longer distances. Other examples include Bluetooth, ultra-wideband (UWB), the IEEE 802.22 standard, etc.

Although only a single utility meter 115 is shown, it is contemplated that the customer premise 105 may include multiple utility meters 115 for different utility services (e.g., different utility meter 115 for water, gas, electric, sewage, etc.). Additionally, although a single utility provider 107 is illustrated in FIG. 1, it is contemplated that there may be any number of utility providers 107, including utility providers associated with different utility services (e.g., gas, electric, water, sewage, etc.) or multiple utility providers associated with the same utility service. Further, although a single customer premise 105 is shown, it is contemplated that there may be any number of customer premises associated with the system 100. Further, multiple customer premises 105 may share one or more similar characteristics and/or relationships. For example, multiple customer premises 105 may be within the same neighborhood, town, city, or state. Multiple customer premises 105 may share the same utility provider 107 or may share the same type of utility meter 115, set-top box 111, and/or network terminal 113. Further, multiple customer premises 105 may share the same customer devices 127 for implementing the utility services, such as the same hot water heater for electric or gas utility services, same air conditioning unit, refrigerator or other large appliances for electric utility services, etc.

As mentioned, the utility meter 115 can be used to measure utility usage for such services as water, gas, electricity, sewage, etc. Traditionally, utility data that is measured by the utility meter 115 is collected and provided to the utility provider 107. This utility data is processed to produce bills on a periodic (e.g., daily, weekly, monthly, quarterly, etc.) basis to the user. Although the utility data is provided to the user through the bills, the utility data is not provided in a way for the user to effectively use the utility data to adjust the consumption of the utility service. Further, other factors may affect the consumption of the utility service that may not be accurately or able to be represented within the utility data provided to the customer. To address this problem, the utility monitoring platform 109 can collect utility data from customer premise equipment associated with the consumption of a utility service at a customer premise 105, determine trends in the utility data, and adjust the consumption of the utility service based on the determined trends and one or more user specified usage criterions.

According to one embodiment, the network terminal 113 is operatively connected to the utility meter 115 and is able to collect utility data from the utility meter 115 in an automated fashion. This is in contrast to the traditional approach of manual collection by a technician. Alternatively, or additionally, the set-top box 111 can operatively be connected to the utility meter 115 to directly collect utility data. Utility data collection can occur based on a predefined schedule or frequency. For example, the network terminal 113 and/or the set-top box 111 can collect utility data on an hourly, daily, weekly, etc. basis. Moreover, such collection can be on an on-demand basis or triggered by an event (e.g., during troubleshooting).

In one embodiment, the set-top box 111, the network terminal 113, and/or the router 117 may be operatively connected to one or more customer devices 127 within the customer premise 105 that consume the utility services. By way of example, the customer devices 127 may be air conditioning units, gas and/or electric heating units, refrigerators, dryers, gas and/or electric ovens, gas and/or electric cooking ranges, sinks, toilets, bathtubs, showers, light bulbs, or any other device at the customer premise that may consume one or more utility services. The customer devices 127 may be operatively connected to the set-top-box 111, the network terminal 113, and/or the router 117 either wired or wirelessly, such as via WiFi, Bluetooth®, ZigBee® or via any other communication medium and/or protocol. For each customer device 127, the user may set one or more thresholds associated with consumption of the utility service. By way of example, for heating, ventilation, and air conditioning (HVAC) units, one or more thresholds may be set to control environmental conditions within the customer premise 105, such as setting the temperature of a thermostat to cool or warm a house. As such, the customer devices 127 may include user interfaces that allow a user to set the one or more thresholds associated with the consumption of the utility service. Further, the customer devices 127 may include one or more application programming interfaces (APIs) that allow for control over the customer devices 127 by the utility monitoring platform 109 or one or more applications executed at the mobile device 121 and device 119.

As discussed, the utility monitoring platform 109 can process the collected utility data and determine usage trends in the utility service. Alternatively or additionally, the functions of the utility monitoring platform 109 can reside within the set-top box 111. The utility monitoring platform 109 can receive utility data that is collected from the utility meter 115 (using the network terminal 113 and/or the set-top box 111), as well as from other meters within other users' premises (not shown) or directly from the customer devices 127 that consume the utility services. The utility monitoring platform 109 can access a utility monitoring database 123 that stores profiles of the users. User profiles can include account information as well as information relating to utility usage, such as user specified usage criterions. The user specified usage criterions may vary depending on the utility service and may represent a periodic cost and/or consumption amount that may be associated with the utility service. By way of example, where the utility service is electric, the user specified usage criterion may be the periodic amount that the user wants to spend on electricity, such as $120 per month. Based on the determined usage trend from analyzing the collected utility data, and a user specified usage criterion, the utility monitoring platform 109 may adjust the consumption of the utility service.

By way of example, if the utility monitoring platform 109 determines a trend in the consumption of the utility service that indicates the consumption of the utility service will exceed a specified usage criterion, the utility monitoring platform 109 may adjust the usage of the utility service at one or more customer devices 127 that consume the utility service. For example, where the service is electricity and it is currently during the summer, if a usage trend indicates that the consumption of electricity will exceed a set monthly amount for electricity (e.g., user specified usage criterion), the utility monitoring platform 109 may adjust the air conditioning unit by raising the temperature of the customer premise to thereby reduce the amount of electricity consumption. This may be performed without requiring a user to manually adjust one or more thresholds associated with the air conditioning unit, such as a set temperature.

The utility monitoring platform 109 may also determine one or more external parameters that affect the consumption of the utility service. The one or more external parameters may include characteristics of the customer premise, environmental conditions, or a combination thereof. The characteristics of the customer premise may be associated with a profile of the user that is stored within the utility monitoring database 123. The characteristics may include one or more characteristics associated with the customer premise 105. Where, for example, the customer premise 105 is a condominium, a characteristic may be the location of the condominium within the condominium building, the size of the building, and any characteristic associated with the building. Where, for example, the customer premise is a single family house, a characteristic may include the size of the house, the number of floors of the house, the number of rooms of the house, whether the house has a basement, insulation characteristics of the house, the age of the house, etc. The characteristics may also include characteristics associated with the one or more customer devices 127. These characteristics may include, for example, model numbers, rating efficiencies, usage ratings, or other characteristics associated with the customer devices 127 that may affect the consumption of utility data by the customer devices 127.

The one or more external parameters may also include environmental conditions. The environmental conditions may be associated with weather surrounding the customer premise 105, such as temperature, humidity, pressure, sky conditions, wind conditions, etc. The environmental conditions may also be the altitude of the customer premise with respect to sea level.

Based on the one or more external parameters that affect consumption of the utility service, the utility monitoring platform 109 may adjust the consumption of the utility service based on the one or more external parameters. By way of example, where the customer premise 105 is house associated with thermal insulation above a set threshold (e.g., determined by one or more insulation metrics), the utility monitoring platform 109 may adjust the HVAC based on the set threshold of insulation. Further, by way of example, where the conditions surrounding a customer premise 105 include sunny conditions, the utility monitoring platform 109 may adjust the HVAC based on the sunny conditions, such as increasing and/or decreasing the consumption of the utility service by the HVAC. Where the customer premise is a single family home as compared to a condominium, the utility monitoring platform 109 may adjust the consumption of utility services with respect to heating and/or cooling of the customer premise more as compared to, for example, a condominium that may experience less change over the course of a day as part of a large building.

In one embodiment, the environmental conditions may be predicted environmental conditions associated with the customer premise 105. For example, the environmental conditions may represent current environmental conditions associated with a customer premise while the predicted environmental conditions may be conditions that are predicted to occur in the future, such as one day, one week, two weeks, one month, etc. in the future. The predicted environmental conditions may be determined by one or more external services, such as one or more weather prediction services that may be accessed by the utility monitoring platform 109 through the communication network 101.

Based on the predicted environmental conditions associated with the customer premise 105 (such as by location), the utility monitoring platform 109 may adjust one or more thresholds associated with the utility services and/or customer devices 127 to adjust the consumption of the utility services. For example, during winter months where gas may be consumed for heating a customer premise 105, current environmental conditions may be associated with average weather conditions for the time of year, such as average temperature conditions. However, predicted environmental conditions may predict colder than average temperature conditions for 10 days starting three days from the current day. Based on this information, the utility monitoring platform 109 may adjust the temperature associated with the gas heater of the customer premise 105 to be set colder than the current setting to reduce the consumption of gas while the temperature conditions are average. The reduction in the consumption of gas while the temperature conditions are average will allow for a greater consumption of gas to heat the customer premise 105 when the temperature conditions are predicted to be lower than average, and therefore potentially require the consumption of more gas to heat the customer premise 105.

The utility monitoring platform 109 may determine a utility rate associated with the consumption of the utility service, the future consumption of the utility service, or a combination thereof. The utility monitoring platform 109 may determine the utility rate from the utility monitoring database 123, the utility provider database 125, or from any other external source, such as one or more information and/or content providers via the Internet. The utility rate may be the current utility rate associated with the consumption of the utility service, such as the price per kilowatt hour for electricity, the price per cubic meter of gas, the price per gallon of water, etc. The utility rate may also, or in the alternative, be the utility rate associated with the future consumption of utility service, such as the future price for electricity, gas, or water, at some point in the future, which may be various time spans as long as there is data. Based on the utility rate, the utility monitoring platform 109 may adjust the consumption of the utility service, in view of the determined usage trend and the user specified usage criterion.

The utility monitoring platform 109 may also determine an issue associated with the consumption of the utility service based on the determined usage trend. The issue may be any issue associated with the consumption of a utility service, such as a predicted over or under consumption of the utility service. For example, a customer premise 105 may be associated with an average consumption of water over a certain period of time. For the same period of time, however, the consumption of water may exceed a set threshold. The set threshold may be the user specified usage criterion, or may be a specified excessive consumption threshold. The specified excessive consumption threshold may indicate more than mere over usage of the utility service, such as a broken gas line or water line, an unauthorized usage of a utility service by another entity, or the like.

Based on the utility monitoring platform 109 determining the issue associated with the consumption of the utility service, the utility monitoring platform 109 may provide a notification, at the customer premise equipment, notifying the customer premise of the issue. Where the customer premise equipment is a set-top box 111, the notification may be provided via the display 116 associated with the set-top box 111.

The notification may have one or more levels of granularity where applicable to the utility monitoring platform 109 determining the issue. For example, the utility monitoring platform 109 may determine that there is a general issue with excessive consumption of water and/or gas. The utility monitoring platform 109 may provide this general notification at the customer premise 105 via the set-top box 111. Where the utility monitoring platform 109 can determine more specificity associated with the issue, the utility monitoring platform 109 may provide the specificity at the customer premise 105, such as indicating that the hot water heater is using excessive water and/or gas to provide hot water. The determination of the issue may help to alleviate the issue more quickly and reduce unintended and/or excessive consumption of the utility service.

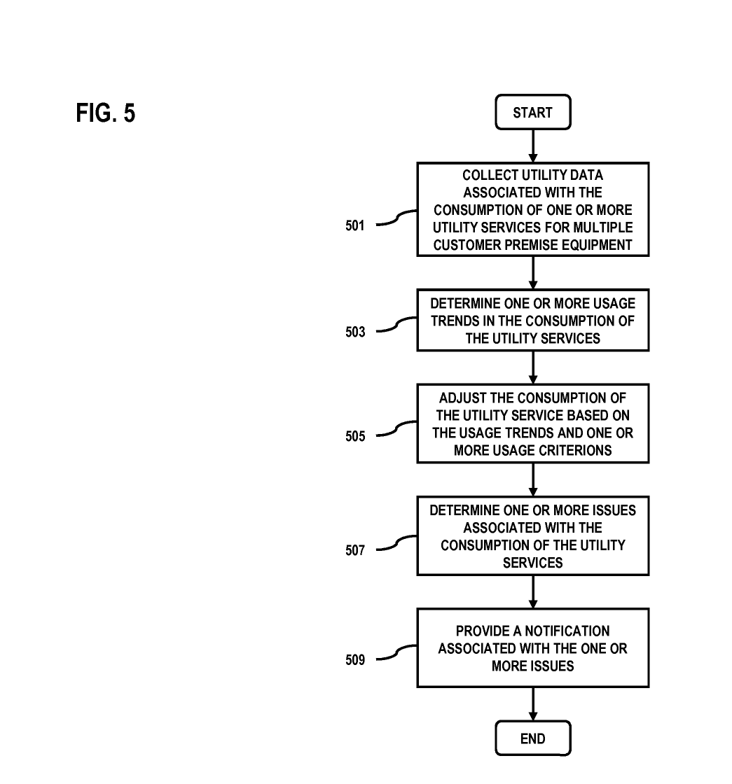

As discussed above, there may be more than one customer premise 105 that is monitored by the utility monitoring platform 109. Accordingly, the functionality discussed above with respect to one customer premise 105 may be performed with respect to more than one customer premise, such as such as collecting utility data associated with consumption of utility services at multiple customer premises, determining one or more usage trends in the consumption of the utility services across the multiple customer premises, and adjusting the consumption of the utility services based on the determined usage trends and one or more user specified usage criterions, as discussed with respect to FIG. 5 below.

Further, in determining one or more issues associated with the consumption of a utility at a customer premise, the utility monitoring platform 109 may determine similar issues associated with one or more other customer premises 105. Alternatively, the utility monitoring platform 109 may determine a single issue associated with a group of customer premises 105, such as houses on a single block. Upon determining one or more issues associated with the consumption of a utility service based on the collected utility data, the utility monitoring platform 109 may notify the utility provider 107 of the utility service of the determined one or more issues. Based on the notification, the utility provider 107 may perform one or more functions to correct the issue associated with the consumption of the utility service.

For example, a group of customer premises 105 may all be associated by having the same type of utility meter 115. An error may occur within the utility meter 115, such as a manufacturing error that eventually causes the utility meter 115 to incorrectly meter the consumption of the utility service. Based on the total determination of the issue affecting the group of customer premises 105, the utility monitoring platform 109 may inform the utility provider 107 such that the utility provider 107 may acknowledge the issue as being widespread rather than local to any one of the customer premises 105. Based on this acknowledgment, the utility provider may alter the response to correct the issue. Further, by determining the utility data associated with consumption of utility services at multiple customer premises 105, the utility data for the multiple customer premises 105 may be used in comparison to the utility data for a single customer premise 105 to determine whether there is an issue with the single customer premise 105.

Further, where the utility monitoring platform 109 is operatively in communication with customer devices 127 that consume the utility service, and the utility meter 115 for the utility service, the utility monitoring platform 109 may compare the utility data from the utility meter 115 with the utility data from the customer devices 127 to determine issues with the consumption of the utility service. For example, the utility data from the utility meter 115 may not match the utility data from the customer devices 127, thereby indicating a potential issue, such as a water and/or a gas leak. This information may be provided as a notification to the customer premise and/or the utility provider to correct the issue or prevent additional issues.

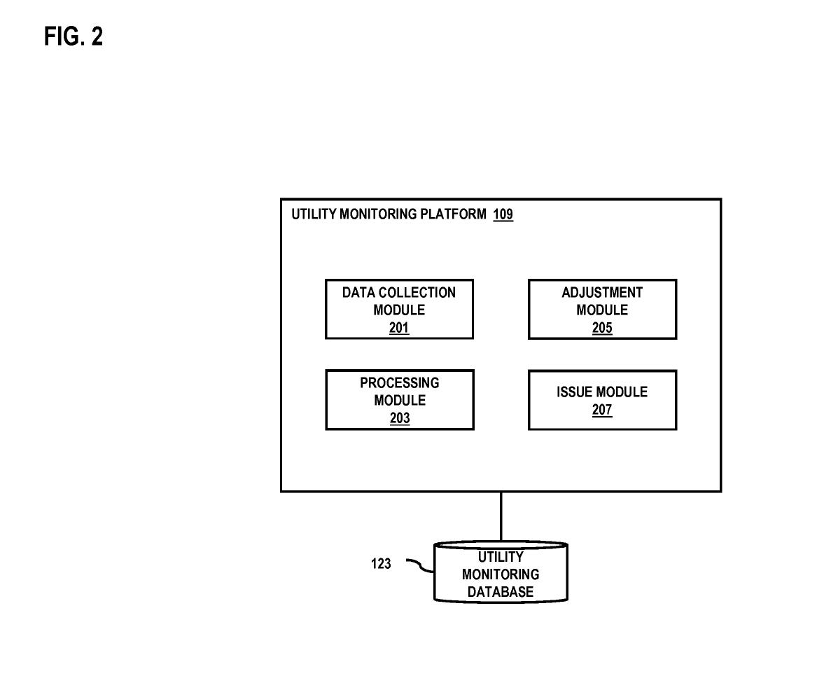

Approaches for adjusting the consumption of utility services based on determined usage trends are more fully described below with respect to FIGS. 2-5.

FIG. 2 is a diagram of components of utility monitoring platform 109 of FIG. 1, according to one embodiment. For the purposes of illustration, the utility monitoring platform 109 can include a data collection module 201, a processing module 203, an adjustment module 205, and an issue module 207. As shown, the utility monitoring platform 109 can be connected to a utility monitoring database 123.

In this example, the data collection module 201 is configured to collect utility data from utility meters (such as the utility meter 115 within the customer premise 105), or directly from the customer devices 127 (e.g., HVAC units, washing machines, dryer, ovens, etc.). The data collection module 201 can directly collect utility data from the utility meters 115 and/or the customer devices 127 or indirectly through the network terminal 113 of the system 100 and/or through the communication network 101. The processing module 203 of the utility monitoring platform 109 can process the collected utility data to determine the one or more trends based on data analytic methods. In one embodiment, the processing module 203 can compare the collected utility data with one or more pre-determined trends or may analyze the collected utility data with one or more algorithms to determine one or more trends in the utility data. In one embodiment, the collected utility data can be made available to the user. The user specified usage criterion can be any metric (e.g., kilowatt hour, gallons, etc.), including cost metrics, such as dollar amount. For example, the user may wish to limit the consumption of utility service usage from exceeding a set cost amount, thereby enabling the user to more easily budget such usage without having to manage one or more control interfaces of one or more customer devices 127.

The adjustment module 205 can control the customer devices 127 for setting one or more thresholds to limit the consumption of utility services. The adjustment module 205 may further control one or more graphical user interfaces associated with the customer devices 127 that allow the user set one or more thresholds for the consumption of a utility service. As discussed above, such as one or more temperature settings, one or more timing controls, one or more environmental controls, etc. The graphical user interfaces can be used to present notification messages to the user, interact with the user to set up a user's profile, interact with the user to dispatch utility service, etc.

The issue module 207 may determine one or more issues associated with the consumption of the utility service based on the determined one or more trends. The issue module 207 may determine the one or more issues based on comparison of the determined trends to one or more excessive consumption thresholds. The issue module 207 may also (or in the alternative) determine one or more issues based on a comparison of utility data collected at the utility meter 115 and the customer devices 127, or based on the utility data collected at the utility meter 115 and output data associated with the utility provider 107, as discussed in more detail with respect to FIG. 5 below.

In the embodiment of FIG. 2, the utility monitoring platform 109 can have access to a utility monitoring database 123. The utility monitoring database 123 can be configured to store user profiles, utility data, information regarding utility providers 107, etc. In one embodiment, the utility monitoring platform 109 can be configured to operate at the set-top box 111 while the utility monitoring database 123 is managed by the service provider.

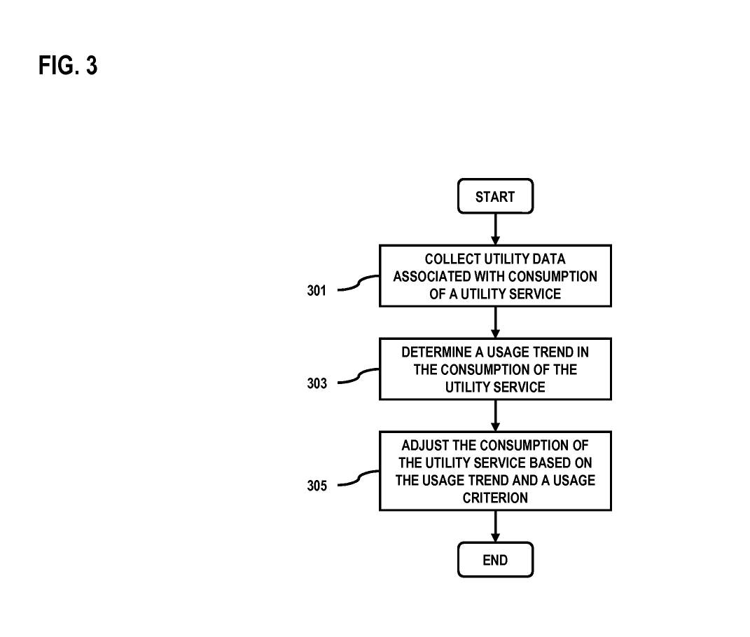

FIG. 3 is a flowchart of a process for adjusting the consumption of utility services based on determined usage trends and user specified usage criterions, according to one embodiment. In one embodiment, the process 300 can be performed at a utility monitoring platform 109 of FIG. 1. It is noted that the steps of the processes may be performed in any suitable order as well as combined or separated in any suitable manner. It is contemplated that utility monitoring platform 109 can be configured to operate at the service provider network 103; also, some or all of the functionalities of the utility monitoring platform 109 can be performed at set-top box 111.

In step 301, utility data associated with consumption of a utility service at a customer premise 105 is collected. The utility data may be collected from a customer premise equipment. In one embodiment, the customer premise equipment may be a set-top box 111 and the set-top box 111 may be configured to present broadcast content. The broadcast content may be provided to the set-top box 111 from the service provider network 103. The utility data may be supplied to the customer premise equipment from a utility meter 115 associated with the utility service or one or more customer devices 127 associated with consumption of the utility service. By way of example, the utility service may be electricity, and the utility data may be acquired from an electricity meter (e.g., utility meter 115), or one or more customer devices 127 that consume electricity, such as a HVAC unit, a dryer, an electric oven, an electric water heater, one or more light bulbs, etc.

In step 303, the utility data associated with consumption of the utility service is forwarded from the customer premise equipment to a service provider network to determine a usage trend in the consumption of the utility service. The service provider network may include the utility monitoring platform 109 that may analyze the utility data to determine the one or more trends. The customer premise equipment, such as the set-top box 111, may forward the utility data to the utility monitoring platform 109 of the service provider network. However, where the operations of the utility monitoring platform 109 are embodied within the customer premise equipment, the forwarding of the utility data may simply constitute forwarding and/or providing access to the utility data for the utility monitoring platform 109 within the customer premise equipment.

The determined usage trend in the consumption of the utility service may be any type of trend in the consumption that relates to, for example, how much utility service is consumed, when the utility service is consumed, how the utility service is consumed, and so forth. The usage trend may be associated with one or more periods, which may be the same periods associated with billing for the utility service. The usage trend may be associated with other periods that are greater in length than the billing periods, such as based on seasons, a year, etc. By way of example, the utility monitoring platform 109 may determine a trend in the consumption of electricity for a billing period of one month. The usage trend may have one or more levels of granularity, such as the total amount of electricity consumed per month, per day, per hour, etc. Where the customer premise equipment is able to communicate with one or more customer devices 127 that consume the utility service, the one or more levels of granularity may also include the customer devices 127 that consume the utility service and specific amounts for each device, such as what amount of the consumption was consumed by the HVAC unit, the electric oven, the dryer, etc. The utility monitoring platform 109 is able to determine one or more patterns of the consumption of the utility service by analyzing the utility data based on one or more algorithms and/or data analytics.

At step 305, the utility monitoring platform 109 may then adjust the consumption of the utility service based on the determined usage trend and a user specified usage criterion. As discussed above, the user specified usage criterion may include an amount of money and/or utility service that the user wants to spend and/or consume for a period of time. For example, the customer may like to spend less than $120 per month on electricity. Based on the determined usage trend and the user specified usage criterion, the utility monitoring platform 109 may adjust the consumption of the utility service. For example, as the amount of utility service consumed for a set period nears the maximum amount, the utility monitoring platform 109 may adjust customer devices 127 that consume the utility service to use less of the utility service. For example, with respect to the utility service of gas, the utility monitoring platform 109 may adjust the one or more thresholds for the HVAC unit of a customer premise 105, such as by lowering the temperature set at a thermostat, to reduce the consumption of gas. With respect to water, for example, the utility monitoring platform 109 may adjust the timing of a sprinkler system associated with the customer premise 105 to shorten the time that the sprinkler system is used to water the lawn associated with the customer premise, thereby reducing the consumption of water. Accordingly, by determining one or more usage trends associated with the consumption of a utility service and adjusting the consumption of the utility service based on the determined usage trends and a user specified usage criterion, the utility monitoring platform 109 allows for control of utility service consumption without manual user control over the consumption of the utility service, thereby a more dynamic control of utility service consumption rather than thresholds associated with customer devices that consume the utility services.

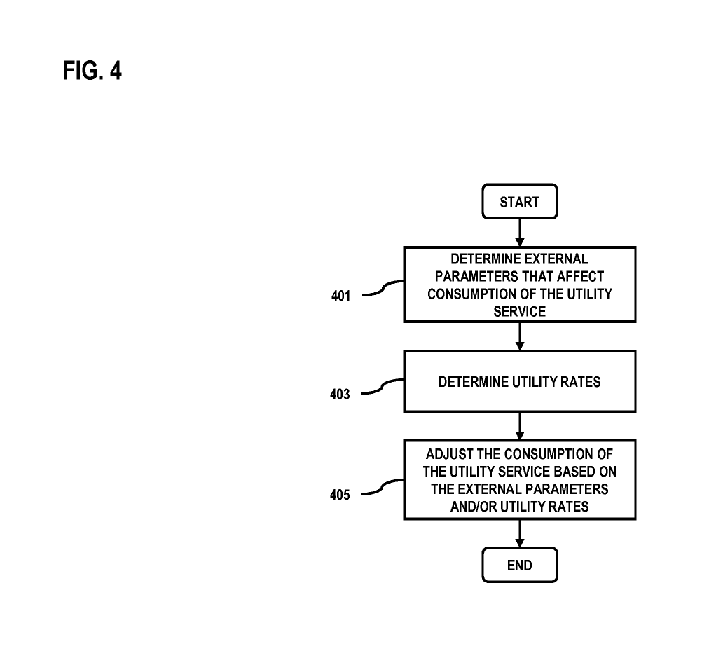

FIG. 4 is a flowchart of a process for accounting for external parameters and/or utility rates in adjusting the consumption of utility services based on determined usage trends, according to one embodiment. It is noted that the steps of the processes may be performed in any suitable order as well as combined or separated in any suitable manner. In one embodiment, the process 400 can be performed at a utility monitoring platform 109 of FIG. 1. It is noted that utility monitoring platform 109 can be configured to operate at the service provider network 103; also, some or all of the functionalities of the utility monitoring platform 109 can be performed at set-top box 111.

In step 401, one or more external parameters that affect the consumption of the utility service may be determined that are associated with characteristics of the customer premise, environmental conditions, or a combination there. In one embodiment, the utility monitoring platform 109 may determine, per step 403, the characteristics and/or environmental conditions directly, or indirectly through the customer premise equipment and/or the customer devices 127. As discussed above, the characteristics of the customer premise 105 may be one or more characteristics that affect the consumption of the utility service, such as the insulation rating of the customer premise, information on the customer devices 127 associated with the customer premise, what customer devices 127 are associated with what utility services at the customer premise, or any other characteristics associated with the customer premise 105, as discussed above, that may affect the consumption of a utility service, including affecting the control over the utility service. By way of example, the efficiency rating of a water heater may be considered as a characteristic of the customer premise based on the efficiency rating affecting the consumption (or efficiency of the consumption) of a utility service, such as gas or electricity. Thus, different water heaters may be controlled differently by the utility monitoring platform 109 depending on the efficiency rating, such as reducing the consumption of a lower efficiency water heater more than a higher efficiency water heater.

The one or more external parameters may also include environmental conditions. The environmental conditions may be associated with weather surrounding the customer premise 105, such as temperature, humidity, pressure, sky conditions, wind conditions, etc. The environmental conditions may be obtained by the customer devices 127, such as by the thermostat of a HVAC unit determining the temperature, or by one or more services over the communication network 101. In one embodiment, the environmental conditions may be predicted environmental conditions associated with the customer premise equipment for set periods in the future, such as one day, one week, one month, etc. in the future. The predicted environmental conditions may be determined based on previous utility data and/or one or more environmental services over the communication network 101.

In one embodiment, in addition to step 401, or instead of step 401, utility rates associated with the consumption of the utility service and/or the future consumption of the utility service, may be determined. The utility monitoring platform 109 may determine the utility rates from the utility provider 107, the utility provider database 125 and/or the utility monitoring database 123. The utility rate may be the price per quantity of utility service consumed, such as a dollar amount per kilowatt hour, gallon, or cubic meter for electricity, water, or gas, respectively. The utility rate may be determined for current consumption of the utility service, or for future consumption of the utility service. The future utility rate may be determined for any time in the future as long as the information is available, such as a day, a week, a month, a year, etc. In one embodiment, the future utility rate may be predicted or estimated based on speculation of future prices of the utility service, such as based on speculated prices for natural gas and/or oil for set times in the future.

In step 405, the utility monitoring platform 109 may then adjust the consumption of the utility service based on one or more of the external parameters and the utility rates, including the current and/or future utility rates, in addition to the determined usage trend and the user specified usage criterion. For example, if the determined trend for the consumption of water indicates that enough hot water would be left over from the water heater at the end of the day, rather than constantly filling the water heater and heating the newly added water during the day, the utility monitoring platform 109 could adjust the hot water heater so that the water is re-filled and heated at night when utility rates for both water and gas are lower. Further, if weather conditions indicate that temperature generally increases during the day and decreases towards late afternoon, the utility monitoring platform 109 may adjust the consumption of a utility service associated with regulating the temperature of the customer premise 105 based on the variation of temperature, such as increasing the cooling during warmer periods of the day and decreasing cooling during cooler periods of the days, or vice versa depending on a user profile associated with the customer premise. Both utility rates and external parameters may be considered when adjusting the consumption of the utility service, such as cooling a house more when the temperature outside is less and when the utility rate associated with the utility service is less, as compared to when the temperature outside is more and when the utility rate is greater. Although the temperature of the customer premise 105 may not be able to be maintained to a set threshold, the cost or amount associated with the utility service may be maintained. Further, the adjustment may consider more than one utility service, such as increasing the heating associated with hot water why reducing the consumption of gas to heat a customer premise 105. Such a condition may be effective where the efficiency of heating water is higher than the efficiency for heating the customer premise 105 such that, although the customer premise 105 is kept colder than before the adjustment, there is sufficient hot water to offset any difference in temperature.

As discussed above, the processes described in FIGS. 3 and 4 may be associated with one customer premise or multiple customer premises. FIG. 5 is a flowchart of a process more specifically describing a process associated with multiple customer premises. Specifically, FIG. 5 is a flowchart of a process for providing notifications associated with issues in the consumption of utility services, according to one embodiment. It is noted that the steps of the processes may be performed in any suitable order as well as combined or separated in any suitable manner. In one embodiment, the process 500 can be performed at utility monitoring platform 109 of FIG. 1. It is noted that utility monitoring platform 109 can be configured to operate at the service provider network 103; also, some or all of the functionalities of the utility monitoring platform 109 can be performed at the set-top box 111.

In step 501, the utility monitoring platform 109 may collect utility data from customer premise equipment associated with the consumption of one or more utility services at more than one customer premise. Further, at step 503, the utility monitoring platform 109 may determine one or more usage trends in the consumption of the utility services with respect to the collected utility data. Thus, the one or more determined trends may be trends associated with one or more customer premises. The one or more determined trends may indicate one or more differences with respect to single customer premises within a group, such as one or more customer premises within a neighborhood of customer premises. The one or more determined trends may also indicate one or more similarities with respect to multiple customer premises within a group.

Further, in step 505, the utility monitoring platform 109 may adjust the consumption of the utility services based on the determined usage trends and one or more user defined usage criterions. By acquiring utility data across a large user base, one or more trends may appear upon analyzing the data according to data analytics that may otherwise not be detectable upon analyzing the utility data individually among the customer premises. By way of example, a trend among multiple customer premises may indicate the heating of customer premises at the same time each morning during the winter to warm the customer premises. Where a utility rate may be based on present demand of the utility, such as for electricity, the present demand may be lessened if each house is heated at separate times during the morning. Accordingly, among a group of customer premises, the utility monitoring platform 109 may control the heating of the customer premises to be sequential to distribute and lessen the demand, and therefore the utility rate, for heating the customer premises. Similarly, if a group of customer premises share a common building, such as condominiums, the utility monitoring platform 109 may vary which unit begins heating in the morning to potentially lessen the initial demand of a single customer premise in warming the customer premise and potentially warming neighboring premises. For example, two customer premises that share the same floor of a two-unit per floor building may trade off between which customer premise begins heating in the morning. Alternatively, the same two customer premises may be adjusted to begin heating at the same time in the morning if previously there was a large disparity between heating start times, causing a large burden to be placed on a single customer premise. Thus, by performing data analytics on utility data among multiple customer premises, the utility monitoring platform 109 offers a wider range of determined trends and adjustment possibilities for controlling the consumption of utility services with respect to one or more user specified usage criterions.

In step 507, the utility monitoring platform 109 may determine one or more issues associated with the consumption of the utility services based on the collected utility data. The one or more issues may be with respect to a single customer premise or with respect to a group of customer premises. For example, the collected utility data for a single customer premise may be above a set excessive consumption threshold indicating one or more issues associated with the utility service, such as one or more broken service lines (e.g., water lines, gas lines, etc.) at the customer premise. Further, where the utility data is collected from both the utility meter 115 and the customer devices 127 that consume the utility service, the utility data may indicate a discrepancy between the consumption of the utility service, further indicating an issue with the service. The one or more issues may alternatively be associated with more than a single customer premise. For example, there may be one or more specified excessive consumption thresholds associated with a group of customer premises that may indicate an issue with a type of utility meter. Further, the utility data reported by the utility meters 115 for a group of customer premises may be cross-checked with output information of the utility provider indicating a potential issue with the delivery network of the utility provider between the customer premises 105 and the utility provider 107.

In step 509, the utility monitoring platform 109 may provide one or more notifications associated with the issues detected at step 507. Depending on the issue, the utility monitoring platform 109 may notify the utility provider 107 and/or the customer premises 105. By way of example, if the issue is widespread, such as that associated with a large water main break or a large gas main break, based on excessive consumption thresholds being broken, the utility monitoring platform 109 may notify the utility provider 107 associated with the utility service. In one embodiment, the utility monitoring platform 109 may also notify one or more other organizations, such as first responders (e.g., fire department, police department, etc.) based on potentially dangerous situations associated with the issue (e.g., a gas explosion). Where the issue is more limited, such as being associated to one or a few customer premises 105, the utility monitoring platform 109 may notify the customer premises 105, such as through set-top boxes, regarding the issue. The customers associated with the customer premises 105 may then take further action to resolve the issue, such as contacting the utility provider. In one embodiment, even for small issues detected by the utility monitoring platform 109, that utility monitoring platform 109 may contact the utility provider to notify the utility provider of the issue.

The described processes and arrangement, in certain embodiments, advantageously enables users to conveniently manage utility service consumption. In one embodiment, this capability can be provided through a set-top box, thereby obviating the need for a separate computer to utilize such service. In this manner, the user is assured that utility data is collected and processed accurately, while permitting certain controls with respect to utility service usage.

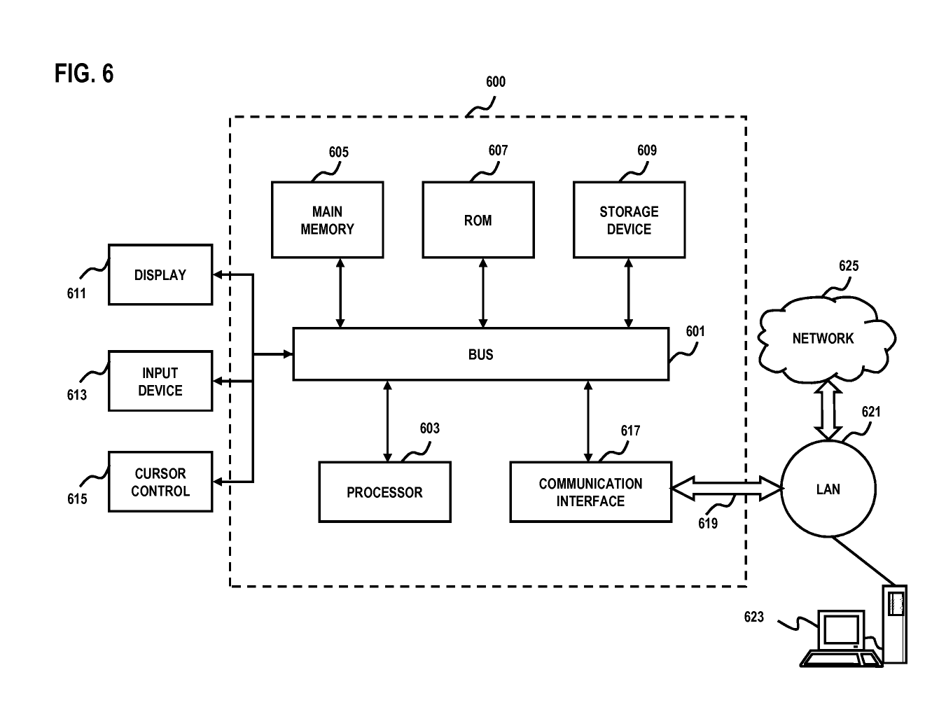

FIG. 6 illustrates computing hardware (e.g., computer system) upon which an embodiment according to the invention can be implemented. The computer system 600 includes a bus 601 or other communication mechanism for communicating information and a processor 603 coupled to the bus 601 for processing information. The computer system 600 also includes main memory 605, such as random access memory (RAM) or other dynamic storage device, coupled to the bus 601 for storing information and instructions to be executed by the processor 603. Main memory 605 also can be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to an embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. Thus, embodiments of the invention are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an embodiment of the invention through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

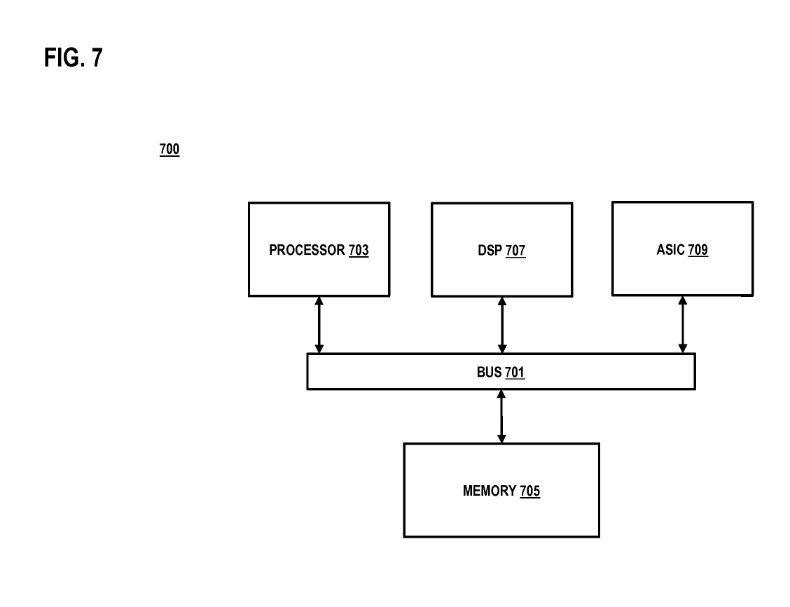

FIG. 7 illustrates a chip set 700 upon which an embodiment of the invention may be implemented. Chip set 700 includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of FIGS. 2-5.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 705 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
collecting utility data, at a customer premise equipment, associated with consumption of a utility service at a customer premise;
forwarding the collected utility data from the customer premise equipment to a service provider network to determine a usage trend in the consumption of the utility service; and
adjusting the consumption of the utility service based on the determined usage trend and a user specified usage criterion.

2. A method according to claim 1, further comprising:
determining one or more external parameters that affect the consumption of the utility service associated with characteristics of the customer premise, environmental conditions, or a combination thereof,
wherein the adjustment of the consumption of the utility service is based on the one or more external parameters.

3. A method according to claim 1, further comprising:
determining utility rates associated with the consumption of the utility service, the future consumption of the utility service, or a combination thereof,
wherein the adjustment of the consumption of the utility service is based on the utility rates.

4. A method according to claim 1, further comprising:
determining predicted environmental conditions associated with the customer premise; and
adjusting the specified usage criterion based on the predicted environmental conditions.

5. A method according to claim 1, wherein the specified usage criterion includes at least one of a cost associated with a period of the consumption of the utility service, one or more threshold amounts for the consumption of the utility service, or a combination thereof.

6. A method according to claim 1, further comprising:
determining an issue associated with the consumption of the utility service; and
providing a notification, at the customer premise equipment, notifying the customer premise of the issue.

7. A method according to claim 1, wherein the customer premise equipment is a set-top box and the set-top box is configured to present broadcast content.

8. An apparatus comprising:
a communication port configured to collect utility data, from a customer premise equipment, associated with consumption of a utility service at a customer premise; and
a processor configured to determine a usage trend in the consumption of the utility service in the collected utility data from the customer premise equipment, and adjusting the consumption of the utility service based on the determined usage trend and a user specified usage criterion.

9. An apparatus according to claim 8, the processor being further configured to:
determine one or more external parameters that affect the consumption of the utility services associated with characteristics of the customer premise, environmental conditions, or a combination thereof,
wherein the adjustment of the consumption of the utility service is based on the one or more external parameters.

10. An apparatus according to claim 8, the processor being further configured to:
determine utility rates associated with the consumption of the utilities, the future consumption of the utilities, or a combination thereof,
wherein the control information is based on the utility rates.

11. An apparatus according to claim 8, the processor being further configured to:
determine predicted environmental conditions associated with the customer premise; and
adjust the one or more thresholds based on the predicted environmental conditions,
wherein the control information is based on the one or more adjusted thresholds.

12. An apparatus according to claim 8, wherein the one or more thresholds include a cost associated with a period of the consumption of the utility service, one or more threshold amounts for the consumption of the utility service, or a combination thereof.

13. An apparatus according to claim 8, the processor being further configured to:
determine an issue associated with the consumption of the utility service; and
receive a notification, at the customer premise equipment, notifying the customer premise of the issue.

14. An apparatus according to claim 8, wherein the customer premise equipment is a set-top box and the set-top box is configured to present broadcast content.

15. A method comprising:
collecting utility data from customer premise equipments associated with consumption of utility services at customer premises;
determine one or more usage trends in the consumption of the utility services; and
adjusting the consumption of the utility services based on the determined usage trends and one or more user specified usage criterions.

16. A method according to claim 15, further comprising:
determining one or more external parameters that affect the consumption of the utility services associated with characteristics of the customer premises, environmental conditions, or a combination thereof,
wherein the adjustment of the consumption of the utility service is based on the one or more external parameters.

17. A method according to claim 15, further comprising:
determining utility rates associated with the consumption of the utility services, the future consumption of the utility services, or a combination thereof,
wherein the control information is based on the utility rates.

18. A method according to claim 15, further comprising:
determining predicted environmental conditions associated with the customer premises; and
adjusting the one or more thresholds based on the predicted environmental conditions,
wherein the control information is based on the one or more adjusted thresholds.

19. A method according to claim 15, further comprising:
determining one or more issues associated with the consumption of a utility service based on the collected utility data; and
notifying the utility provider of the utility service of the determined one or more issues.

20. A method according to claim 15, further comprising:
determining an issue associated with a utility service at a customer premise based on a comparison of consumption of the utility service associated with the customer premise and consumption of the utility service associated with the customer premises; and
providing a notification, at customer premise equipment of the customer premise, notifying the customer premise of the issue.
